(19) United States
(12) Patent Application Publication
(10) Pub. No.: US 2019/0386344 A1
(43) Pub. Date: Dec. 19, 2019

(54) NONAQUEOUS ELECTROLYTE SECONDARY BATTERY

(71) Applicant: SANYO Electric Co., Ltd., Daito-shi, Osaka (JP)

(72) Inventors: Shinji Kasamatsu, Tokushima (JP); Yuta Ichikawa, Osaka (JP)

(73) Assignee: SANYO Electric Co., Ltd., Daito-shi, Osaka (JP)

(21) Appl. No.: 16/487,632

(22) PCT Filed: Feb. 13, 2018
(86) PCT No.: PCT/JP2018/004778

§ 371 Date: Aug. 21, 2019

(30) Foreign Application Priority Data
Feb. 24, 2017 (JP) 2017-033101

(51) Int. Cl. H01M 10/0587

(52) U.S. Cl. CPC H01M 10/0587

(57) ABSTRACT

A nonaqueous electrolyte secondary battery is disclosed including a flat electrode body in which an electrode group including a positive electrode plate, a negative electrode plate, and a separator interposed therebetween is rolled, a nonaqueous electrolyte, and an outer jacket member. The electrode body includes bent portions, in which an electrode group is bent, at both end portions in the major axis direction of a cross section perpendicular to a rolling axis. A resin tape is attached to a portion, which is arranged nearest the rolling start position of the positive electrode plate, of the roll inner surface of the positive electrode mix layer in the bent portion. The resin tape includes an adhesive layer and a base material layer that does not pass lithium ions. An adhesive force of the resin tape to the positive electrode mix layer is 0.1 N/cm or more and 2 N/cm or less.

### TECHNICAL FIELD

The present invention relates to a nonaqueous electrolyte secondary battery including a flat-rolled electrode body.

### BACKGROUND ART

Nonaqueous electrolyte secondary batteries have been widely used as drive power supplies for portable electronic equipment, for example, smartphones, tablet type computers, notebook personal computers, and portable music players. In particular, a pouch-type nonaqueous electrolyte secondary battery, in which a pouch outer jacket member composed of a laminate sheet is used as an outer jacket member, is suitable for thin electronic equipment.

A flat-rolled electrode body is used for the pouch-type nonaqueous electrolyte secondary battery. The rolled electrode body is produced by flat-rolling an electrode group composed of a positive electrode, a negative electrode, and a separator interposed therebetween about a roll core axis. Bent portions, in which the electrode group is convexly bent outward from the electrode body, are formed at both end portions in the major axis direction of a cross section perpendicular to the rolling axis of the flat electrode body.

In general, a nonaqueous electrolyte secondary battery is designed such that the ratio of the charge capacity of a negative electrode to the charge capacity of a positive electrode (negative-to-positive electrode capacity ratio) is more than 1. Consequently, lithium is prevented from being deposited on the negative electrode during charging. The design value of the negative-to-positive electrode capacity ratio is determined in accordance with the amount of active material per unit area of each of the positive electrode plate and the negative electrode plate. However, the bent portion of the flat electrode body has a structure in which an outer-circumference-side electrode plate wraps the inner-circumference-side electrode plate. Therefore, an outer electrode plate has a larger occupation volume in the bent portion. As a result, in the bent portion, the negative-to-positive electrode capacity ratio, that is, the capacity ratio of the roll outer surface of the negative electrode plate (outer surface in the radial direction of the electrode body) to the roll inner surface of the positive electrode plate corresponding to the roll outer surface (inner surface in the radial direction of the electrode body), is smaller than the design value.

The above-described deviation of the negative-to-positive electrode capacity ratio increases as the inner circumference of the electrode body approaches. Consequently, the negative electrode may be overcharged in the portion nearest the rolling start position in a positive-negative electrode opposing portion in the bent portion. In the case in which the design value of the negative-to-positive electrode capacity ratio is sufficiently large, such a problem does not readily occur. However, to increase the capacity of the nonaqueous electrolyte secondary battery, it is desirable that the negative-to-positive electrode capacity ratio be minimized. Therefore, measures to address the above-described problems have been researched.

PTL 1 discloses that lithium is prevented from being deposited on a negative electrode by attaching an insulating resin tape to the roll inner surface of the bent portion nearest the rolling start position of a positive electrode plate. Meanwhile, PTL 2 discloses a battery in which an innermost portion of the bent portion of a positive-negative electrode active layer opposing portion is not involved in charge and discharge. Specifically, in the same manner as PTL 1, it is disclosed that an insulating resin tape is attached to the roll inner surface of the bent portion nearest the rolling start position of a positive electrode plate.

### CITATION LIST

### Patent Literature

PTL 1: Japanese Published Unexamined Patent Application No. 2003-157902

PTL 2: Japanese Published Unexamined Patent Application No. 2008-41581

### SUMMARY OF INVENTION

### Technical Problem

According to the technologies disclosed in PTL 1 and PTL 2, the negative electrode in the bent portion can be prevented from being overcharged. However, in the case in which a resin tape is attached to the surface of the positive electrode plate in the bent portion, cracks may occur in a positive electrode core due to the resin tape. In the case in which a positive electrode mix layer is disposed in the bent portion, when the positive electrode plate is bent, the flexibility of the positive electrode plate is facilitated by the occurrence of fine cracks in the positive electrode mix layer. However, if a resin tape is attached to the surface of the positive electrode mix layer, fine cracks do not readily occur in the positive electrode mix layer. Consequently, if a portion to which the resin tape has been attached is bent at a large curvature, cracks may readily occur in the positive electrode core. The occurrence of cracks may cause the positive electrode core to break due to expansion and shrinkage of the negative electrode plate or the positive electrode plate in accordance with charge-discharge cycles.

PTL 1 discloses that attachment of the resin tape to the positive electrode plate prevents the positive electrode core from being damaged. However, the effect is on the basis of a reduction in the curvature of the bent portion due to attachment of the resin tape. Neither PTL 1 nor 2 considers that the flexibility of the positive electrode plate is lost by attachment of the resin tape.

The present invention was realized in consideration of the above, and it is an object to prevent local overcharge of a negative electrode in a bent portion of a flat electrode body and, in addition, to suppress the occurrence of cracks in a positive electrode core in the bent portion.

### Solution to Problem

To address the above-described problems, a nonaqueous electrolyte secondary battery according to an aspect of the present invention includes a flat electrode body in which an electrode group including a positive electrode plate, a negative electrode plate, and a separator interposed therebetween is rolled, a nonaqueous electrolyte, and an outer jacket member. The positive electrode plate includes a positive electrode core and a positive electrode mix layer disposed on the surface of the positive electrode core, and the negative electrode plate includes a negative electrode core and a negative electrode mix layer disposed on the surface of the negative electrode core. The electrode body includes bent portions, in which an electrode group is bent, at both end portions in the major axis direction of a cross section perpendicular to a rolling axis. A resin tape is attached to a portion, which is arranged nearest the rolling start position of the positive electrode plate, of the roll inner surface of the positive electrode mix layer in the bent portion. The resin tape includes an adhesive layer and a base material layer that does not allow flow of lithium ions. The adhesive force of the resin tape to the positive electrode mix layer is 0.1 N/cm or more and 2 N/cm or less.

### Advantageous Effects of Invention

According to an aspect of the present invention, local overcharge of a negative electrode in a bent portion of a flat electrode body can be prevented and, in addition, the occurrence of cracks in a positive electrode core in the bent portion can be suppressed.

### BRIEF DESCRIPTION OF DRAWINGS

FIG. 1 is a schematic sectional view of a flat electrode body according to an embodiment.

FIG. 2 is a magnified diagram of a key portion of a bent portion in FIG. 1.

FIG. 3 is a perspective view of a nonaqueous electrolyte secondary battery according to an embodiment.

### DESCRIPTION OF EMBODIMENTS

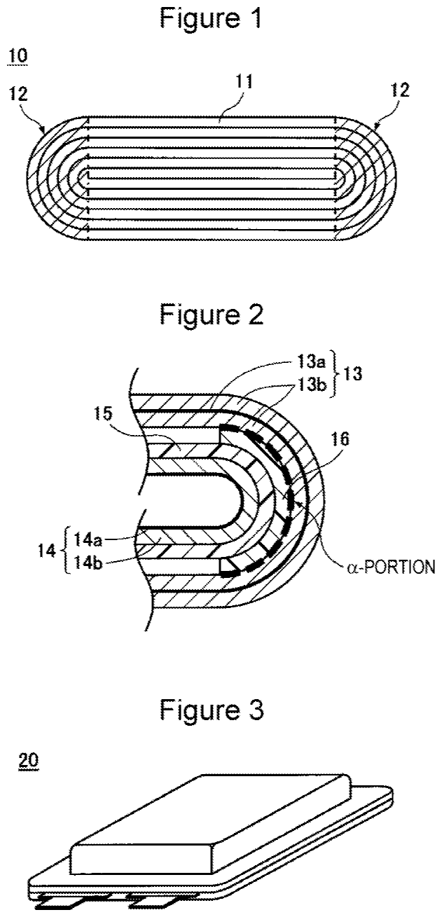

An embodiment according to the present invention will be described with reference to FIGS. 1 and 2 schematically showing a cross section perpendicular to the rolling axis of a flat electrode body. An electrode body 10 can be produced by, for example, rolling a positive electrode plate 13 and a negative electrode plate 14 with a separator 15 interposed therebetween and forming the resulting rolled electrode body into a flat shape by pressing. As shown in FIG. 1, the cross section perpendicular to the rolling axis of the flat electrode body 10 has a structure in which an electrode group 11 is sequentially stacked from the roll inner side (inner side in the radial direction) toward the roll outer side (outer side in the radial direction), the electrode group 11 being composed of the positive electrode plate 13, the negative electrode plate 14, and the separator 15 stacked. Bent portions 12, in which the electrode group 11 is bent, are disposed at both end portions in the major axis direction of the cross section.

A resin tape 16 is attached to a portion, which is arranged nearest the rolling start position, (α-portion indicated by a broken line in FIG. 2) of the roll inner surface of a positive electrode mix layer 13b in the bent portion 12. It is preferable that the resin tape 16 be attached so as to cover the entire region of the α-portion, or part of the resin tape 16 may be attached beyond the α-portion. The location to which the resin tape 16 is attached is not limited to the α-portion, and the resin tape may also be attached to the surface of the positive electrode mix layer 13b rolled outside the α-portion. However, local overcharge of the negative electrode can be effectively prevented as long as the resin tape 16 is attached to the α-portion. The region occupied by the α-portion is very small relative to the total area of the front and back of the positive electrode plate and, therefore, the influence exerted on the battery capacity by attachment of the resin tape 16 to the α-portion is small.

As shown in FIG. 2, the positive electrode mix layers 13b are disposed on both surfaces of the positive electrode core 13a. A negative electrode mix layer 14b is arranged so as to oppose the positive electrode mix layer 13b with the separator 15 interposed therebetween. No positive electrode plate 13 is rolled inside the innermost turn of the negative electrode plate 14 and, therefore, no negative electrode mix layer 14b is disposed on the roll inner surface of the negative electrode core 14a of the innermost turn of the negative electrode plate 14. In this regard, in FIG. 2, the separator 15 disposed inside the innermost turn of the negative electrode plate 14 is not shown in the drawing.

The resin tape includes at least two layers composed of a base material layer that does not pass lithium ions in a nonaqueous electrolyte and an adhesive layer. When the base material layer that does not pass lithium ions is included, a charge-discharge reaction does not occur in the positive-negative electrode opposing portion in the α-portion. Consequently, local overcharge of the negative electrode is effectively prevented.

The resin film that does not pass lithium ions and that can stably present in a nonaqueous electrolyte is usable for the base material layer of the resin tape with no limitation. Examples of a resin material usable for the base material layer include polyethylenes, polypropylenes, polyethylene terephthalates, polyvinyl alcohols, and polyimides. There is no particular limitation regarding the thickness of the base material layer, and 12 μm or less is preferable because the flexibility of the resin tape is sufficiently ensured. In this regard, to ensure the mechanical strength of the resin tape 16, the thickness of the base material layer is preferably 1 μm or more.

The adhesive force of the resin tape to the positive electrode mix layer is preferably 2 N/cm or less. When the adhesive force of the resin tape to the positive electrode mix layer is 2 N/cm or less, in the case in which a portion with the resin tape attached is bent at a large curvature, part of the adhesive layer peels off the positive electrode mix layer, and fine cracks occur in the positive electrode mix layer. Consequently, the flexibility of the positive electrode plate is facilitated, and when the positive electrode plate is bent at a large curvature, the positive electrode core is prevented from cracking. It is sufficient that the resin tape has an adhesive force to maintain the state of being attached to the positive electrode mix layer until the electrode group is rolled. For example, the adhesive force of the resin tape to the positive electrode mix layer 13b is preferably 0.1 N/cm or more.

Examples of the adhesive used for the adhesive layer of the resin tape include acrylic adhesives and rubber-based adhesives, although the adhesive is not limited to these. The adhesive force of the resin tape to the positive electrode mix layer can be adjusted by changing the components of the adhesive or the thickness of the adhesive layer. For example, when the thickness of the adhesive layer is 3 μm or less, the amount of the adhesive that penetrates the positive electrode mix layer is reduced. Consequently, the adhesive force of the resin tape to the positive electrode mix layer can be readily adjusted to 2 N/cm or less. The resin tape has to maintain the state of being attached to the positive electrode mix layer until the electrode group is rolled and, therefore, the thickness of the adhesive layer is preferably 0.1 μm or more.

The mix layer can be formed by coating the core with a mix slurry, which is produced by kneading an active material and a binder in a dispersion medium, and performing drying. The resulting mix layer is compressed so as to have a predetermined thickness. As the situation demands, a conductive material and a thickener may be added to the mix slurry. It is preferable that metal foil be used for the core, aluminum foil be used for the positive electrode core, and copper foil be used for the negative electrode core. Each of the aluminum foil and the copper foil may contain a very small amount of other types of metals.

Regarding a positive electrode active material, a lithium transition metal complex oxide that can reversibly occlude and release lithium ions may be used. Examples of the lithium transition metal complex oxide include oxides denoted by general formula LiMO₂ (M represents at least one of Co, Ni, and Mn), LiMn₂O₄, and LiFePO₄. These may be used alone, or at least two types may be used in combination. At least one selected from a group consisting of Al, Ti, Mg, and Zr may be added or may substitute for a transition metal element.

Regarding a negative electrode active material, a carbon material, for example, artificial graphite, natural graphite, non-graphitizable carbon, or graphitizable carbon, that can reversibly occlude and release lithium ions may be used. In addition, silicon and tin and oxides thereof may be used. These may be used alone, or at least two types may be used in combination.

Regarding the separator, microporous films composed of polyolefins, for example, polyethylenes and polypropylenes, may be used. In addition, a separator in which a plurality of microporous films having different compositions are stacked may be used. In the case in which a multilayer separator is used, it is preferable to adopt a three-layer structure in which a layer containing a polyethylene having a low melting temperature as a primary component is used for an intermediate layer and a layer containing a polypropylene having excellent oxidation resistance is used for surface layers. The intermediate layer containing a polyethylene as a primary component performs a shutdown function of clogging the separator and interrupting a current between the positive electrode and the negative electrode when a battery temperature increases. Further, inorganic particles such as aluminum oxide (Al₂O₃), titanium oxide (TiO₂), or silicon oxide (SiO₂) may be added to the separator. The inorganic particles may be carried by the separator or be applied with a binder to the separator surface. Alternatively, an aramid resin having excellent heat resistance may be applied to the separator surface.

Regarding the nonaqueous electrolyte, a nonaqueous solvent in which a lithium salt is dissolved as an electrolyte salt may be used. A nonaqueous electrolyte using a gel polymer instead of or in combination with a nonaqueous solvent may be used.

Regarding the nonaqueous solvent, cyclic carbonic acid esters, chain carbonic acid esters, cyclic carboxylic acid esters, and chain carboxylic acid esters may be used. Preferably, at least two types of these are used in combination. Examples of the cyclic carbonic acid ester include ethylene carbonate (EC), propylene carbonate (PC), and butylene carbonate (BC). In addition, a cyclic carbonic acid ester such as fluoroethylene carbonate (FEC) in which some hydrogen atoms are substituted with fluorine atoms may also be used. Examples of the chain carbonic acid ester include dimethyl carbonate (DMC), ethylmethyl carbonate (EMC), diethyl carbonate (DEC), and methylpropyl carbonate (MPC). Examples of the cyclic carboxylic acid ester include γ-butyrolactone (γ-BL) and γ-valerolactone (γ-VL). Examples of the chain carboxylic acid ester include methyl pivalate, ethyl pivalate, methyl isobutyrate, and methyl propionate.

Examples of the lithium salt include LiPF₆, LiBF₄, LiCF₃SO₃, LiN(CF₃SO₂)₂, LiN(C₂F₅SO₂)₂, LiN(CF₃SO₂)(C₄F₉SO₂), LiC(CF₃SO₂)₃, LiC(C₂F₅SO₂)₃, LiAsF₆, LiClO₄, Li₂B₁₀Cl₁₀, and Li₂B₁₂Cl₁₂. Of these, LiPF₆ is particularly preferable, and the concentration in the nonaqueous electrolyte is preferably 0.5 to 2.0 mol/L. Other lithium salts, for example, LiBF₄, may be mixed into LiPF₆.

Regarding the outer jacket member to store the flat electrode body, a pouch-type outer jacket member composed of a laminate sheet or an aluminum prismatic outer jacket may be used.

### EXAMPLES

The forms for realizing the present invention will be described below in detail with reference to the example. However, the present invention is not limited to the example described below. The present invention can be appropriately modified and applied within the bounds of not changing the gist of the present invention.

(Production of Positive Electrode Plate)

Mixing of 95 parts by mass of lithium cobaltate (LiCoO₂) serving as a positive electrode active material, 2.5 parts by mass of carbon black serving as a conductive agent, and 2.5 parts by mass of polyvinylidene fluoride (PVdF) serving as a binder was performed. The resulting mixture was put into N-methylpyrrolidone (NMP) serving as a dispersion medium, and kneading was performed so as to produce a positive electrode mix slurry. The resulting positive electrode mix slurry was applied to both surfaces of a positive electrode core composed of aluminum foil having a thickness of 12 μm, and drying was performed so as to form a positive electrode mix layer. At this time, a positive-electrode-core-exposed portion, in which no positive electrode mix layer was formed, was disposed at part of the positive electrode core. Subsequently, the positive electrode mix layer after drying was compressed by a roller such that the filling density became 3.6 g/cm³ and cut into a predetermined size. Finally, an aluminum positive electrode tab was connected to the positive-electrode-core-exposed portion so as to produce a positive electrode plate.

(Production of Negative Electrode Plate)

Mixing of 97 parts by mass of artificial graphite serving as a negative electrode active material, 2 parts by mass of styrene-butadiene rubber (SBR) serving as a binder, and 1 part by mass of carboxymethyl cellulose (CMC) serving as a thickener was performed. The resulting mixture was put into water serving as a dispersion medium, and kneading was performed so as to produce a negative electrode mix slurry. The resulting negative electrode mix slurry was applied to both surfaces of a negative electrode core composed of copper foil having a thickness of 8 μm, and drying was performed so as to form a negative electrode mix layer. At this time, a negative-electrode-core-exposed portion, in which no negative electrode mix layer was formed, was disposed at part of the negative electrode core. Subsequently, the negative electrode mix layer after drying was compressed by a roller such that the filling density became 1.6 g/cm³ and cut into a predetermined size. Finally, a nickel negative electrode tab was connected to the negative-electrode-core-exposed portion so as to produce a negative electrode plate.

(Production of Electrode Plate)

An electrode group in which the positive electrode plate and the negative electrode plate were stacked with a separator composed of a polyethylene microporous film having a thickness of 16 μm interposed therebetween was rolled, and the resulting rolled electrode body was formed by a hot press so as to produce a flat electrode body. Before the electrode group was rolled, a resin tape was attached to the first portion, which was to be arranged in the bent portion, of the roll inner surface of the positive electrode mix layer in the bent portion of the electrode body. A polyolefin film having a thickness of 12 μm was used for a base material layer of the resin tape. Regarding the adhesive layer of the resin tape, an acrylic adhesive was used and the thickness thereof was set to be 3 μm.

(Preparation of Nonaqueous Electrolyte)

A nonaqueous solvent was prepared by mixing ethylene carbonate (EC) and methylethyl carbonate (MEC) in a proportion of 30:70 on a volume ratio basis. Lithium hexafluorophosphate (LiPF₆) was dissolved into the resulting nonaqueous solvent such that the concentration became 1 mol/L, and vinylene carbonate (VC) was further added so as to prepare a nonaqueous electrolyte. In this regard, the amount of vinylene carbonate added was set to be 1% by mass relative to the nonaqueous electrolyte.

(Production of Nonaqueous Electrolyte Secondary Battery)

The electrode body produced as described above was stored in a pouch outer jacket member composed of a laminate sheet, and the outer circumferential portion of the pouch outer jacket member, excluding an electrolyte injection hole, was heat-sealed so as to produce a battery before electrolyte injection. The nonaqueous electrolyte was injected into the resulting battery before electrolyte injection through the electrolyte injection hole and, thereafter, the electrolyte injection hole was heat-sealed so as to produce a nonaqueous electrolyte secondary battery 20, shown in FIG. 3, having a design capacity of 1,000 mAh.

### Comparative Example 1

An electrode body and a nonaqueous electrolyte secondary battery according to comparative example 1 were produced in the same manner as the example except that the thickness of the base material layer of the resin tape was set to be 20 μm and the thickness of the adhesive layer was set to be 5 μm.

### Comparative Example 2

An electrode body and a nonaqueous electrolyte secondary battery according to comparative example 2 were produced in the same manner as comparative example 1 except that a rubber-based adhesive containing styrene-butadiene rubber was used instead of the acrylic adhesive and the thickness of the adhesive layer was set to be 10 μm.

### Comparative Example 3

An electrode body and a nonaqueous electrolyte secondary battery according to comparative example 3 were produced in the same manner as the example except that the resin tape was not used.

(Measurement of Adhesive Force of Resin Tape to Positive Electrode Mix Layer)

The adhesive force of the resin tape to the positive electrode mix layer was measured as described below. Initially, a portion provided with the positive electrode mix layer on both surfaces of the positive electrode core in the positive electrode plate was cut into the size of 2 cm×5 cm. A resin tape was attached to the surface of the cut positive electrode plate. A portion not attached to the positive electrode plate of the resin tape was pulled at an angle of 90° relative to the positive electrode plate and at a rate of 20 mm/min until the resin tape was completely peeled off the positive electrode plate, and the measured maximum load was taken as the adhesive force (N/cm) of the resin tape to the positive electrode mix layer. The measurement result of the adhesive force of the resin tape to the positive electrode mix layer used in each of the example and comparative examples 1 and 2 is shown in Table 1.

(Examination of Presence or Absence of Crack in Positive Electrode Core)

The flat electrode body after forming by a hot press in each of the example and comparative examples 1 and 2 was disassembled, and whether cracks occurred in the positive electrode core of the α-portion to which the resin tape was attached, as shown in FIG. 2, was examined by an optical microscope. In addition, regarding comparative example 3, whether cracks occurred in the positive electrode core of the α-portion was examined in the same manner. The results are shown in Table 1.

(Charge-Discharge Cycle)

Regarding a battery according to each of the example and comparative examples 1 to 3, a charge-discharge cycle was performed under the following condition. Initially, each battery was charged at a constant current of 1 lt (=1,000 mA) until the voltage reached 4.2 V. Subsequently, charging was performed at a constant voltage of 4.2 V until the current reached 1/50 lt (=20 mA). After a suspension of 10 minutes, each battery was discharged at a constant current of 1 lt until 2.75 V was reached. This charge-discharge was repeated 100 cycles.

(Examination of Presence or Absence of Deposition of Lithium)

The electrode body taken out of each battery after the charge-discharge cycle was disassembled, and presence or absence of deposition of lithium (Li) on the negative electrode facing the α-portion was visually examined. The results are shown in Table 1.

TABLE 1

| | Material of tape | | | Crack in | |
|---|---|---|---|---|---|
| | Base | | Adhesive | positive | |
| | material | Adhesive | force of | electrode | Deposition |
| | layer | layer | tape (N/cm) | core | of Li |
| Example | PP | acrylic | 1.5 | none | none |
| Comparative | PP | acrylic | 2.5 | yes | none |
| example 1 | | | | | |
| Comparative | PP | rubber- | 4.5 | yes | none |
| example 2 | | based | | | |

| | | | | |
|---|---|---|---|---|
| Comparative | none | — | none | yes |
| example 3 | | | | |

In comparative example 3 in which no resin tape was attached to the α-portion, no crack was observed in the positive electrode core, whereas in each of comparative examples 1 and 2 in which the resin tape was attached to the α-portion, cracks were observed in the positive electrode core. This result indicates that the resin tape may cause damage to the positive electrode core. If the resin layer is firmly attached to the positive electrode mix layer, fine cracks do not readily occur in the positive electrode mix layer during bending of the positive electrode plate. As a result, the flexibility of the positive electrode mix layer is impaired, and cracks readily occur in the positive electrode core.

On the other hand, in the example in which the resin tape was attached to the α-portion, no crack was observed in the positive electrode core. The adhesive force of the resin tape to the positive electrode mix layer in the example was smaller than the adhesive force of the resin tape in each of comparative examples 1 and 2. Since the adhesive force of the resin tape was reduced, part of the resin tape was peeled off the positive electrode mix layer during bending of the portion in which the resin tape was attached, and cracks occurred in the positive electrode mix layer. Consequently, it is conjectured that the flexibility of the positive electrode mix layer was facilitated, and the occurrence of cracks in the positive electrode core was prevented. The adhesive force of the resin tape to the positive electrode mix layer in the example was 1.5 N/cm, and when the adhesive force was 2 N/cm or less, the same effect as that in the example was exerted.

Meanwhile, in the example, deposition of lithium on the negative electrode facing the α-portion after the charge-discharge cycle was not observed. Even when the adhesive force of the resin tape was reduced, deviation of the location of the resin tape did not occur during the charge-discharge cycle and local overcharge of the negative electrode could be prevented as long as the resin tape was reliably fixed to the α-portion of the positive electrode plate during rolling of the electrode group.

### INDUSTRIAL APPLICABILITY

According to the present invention, local overcharge of a negative electrode in a bent portion of an electrode body can be prevented and, in addition, the occurrence of cracks in a positive electrode core can be suppressed. Further, the negative-to-positive electrode capacity ratio can be reduced, and the capacity of a nonaqueous electrolyte secondary battery can be increased. Therefore, the present invention can be industrially exploited to a great extent.

### REFERENCE SIGNS LIST

11 electrode group
12 bent portion
13 positive electrode plate
13a positive electrode core
13b positive electrode mix layer
14 negative electrode plate
14a negative electrode core
14b negative electrode mix layer
15 separator
16 resin tape
20 nonaqueous electrolyte secondary battery

1. A nonaqueous electrolyte secondary battery comprising a flat electrode body in which an electrode group including a positive electrode plate, a negative electrode plate, and a separator interposed therebetween is rolled, a nonaqueous electrolyte, and an outer jacket member,
wherein the positive electrode plate includes a positive electrode core and a positive electrode mix layer disposed on the positive electrode core,
the negative electrode plate includes a negative electrode core and a negative electrode mix layer disposed on the negative electrode core,
the electrode body includes bent portions, in which an electrode group is bent, at both end portions in the major axis direction of a cross section perpendicular to a rolling axis,
a resin tape is attached to a portion, which is arranged nearest the rolling start position of the positive electrode plate, of the roll inner surface of the positive electrode mix layer in the bent portion,
the resin tape includes an adhesive layer and a base material layer that does not pass lithium ions, and
the adhesive force of the resin tape to the positive electrode mix layer is 0.1 N/cm or more and 2 N/cm or less.

2. The nonaqueous electrolyte secondary battery according to claim 1, wherein the thickness of the base material layer is 1 μm or more and 12 μm or less.

3. The nonaqueous electrolyte secondary battery according to claim 2, wherein the thickness of the adhesive layer is 0.1 μm or more and 3 μm or less.
